(19) United States
(12) Patent Application Publication
(10) Pub. No.: US 2021/0240516 A1
(43) Pub. Date: Aug. 5, 2021

(54) DISTRIBUTED TRANSACTION MANAGEMENT

(71) Applicant: INTERNATIONAL BUSINESS MACHINES CORPORATION, Armonk, NY (US)

(72) Inventors: Xiao Yuan XY Ma, Beijing (CN); Xue Yong ZHANG, Beijing (CN); Xi Bo Zhu, Beijing (CN); Guan Jun LIU, Beijing (CN); Shi Yu Wang, Beijing (CN)

(21) Appl. No.: 16/782,125

(22) Filed: Feb. 5, 2020

(51) Int. Cl. G06F 9/46; G06Q 20/40

(52) U.S. Cl. CPC G06F 9/466; G06Q 20/405; G06Q 20/407

(57) ABSTRACT

Embodiments of the present invention relate to methods, systems, and computer program products for distributed transaction management. In a method, a first transaction is performed, where both a first data in a first application system and a second data in a second application system are to be accessed in the first transaction. A second transaction is identified in response to a determination that the second data in the second application system fails to be accessed in the first transaction, the first data in the first application system being accessed in the second transaction during performing the first transaction. A value of the first data is determined based on status of the first transaction and status of the second transaction.

### BACKGROUND

The present invention relates to distributed transaction management. Specifically, the present invention relates to computer-implemented methods, computer-implemented systems and computer program products for managing distributed transactions among a plurality of application systems.

With developments of computer and network technology, more and more transactions are performed in a distributed manner. For example, in an online shopping service, a plurality of application systems, such as a repository system, a payment system, a coupon system, a delivery system, and the like, may be accessed. If a data in any one of the above application systems fails to be accessed in the shopping transaction, the shopping transaction may be failed and data in all the application systems should be rolled back to their previous values.

### SUMMARY

According to one embodiment of the present invention, there is provided a computer-implemented method. In the method, a first transaction is performed, where both a first data in a first application system and a second data in a second application system are to be accessed in the first transaction. A second transaction is identified in response to a determination that the second data in the second application system fails to be accessed in the first transaction, the first data in the first application system being accessed in the second transaction during performing the first transaction. A value of the first data is determined based on status of the first transaction and status of the second transaction.

According to another embodiment of the present invention, there is provided a computer-implemented system. The computer-implemented system comprises a computer processor coupled to a computer-readable memory unit, where the memory unit comprises instructions that when executed by the computer processor implements the above method.

According to another embodiment of the present invention, there is provided a computer program product. The computer program product comprises a computer readable storage medium having program instructions embodied therewith. The program instructions are executable by an electronic device to cause the electronic device to perform actions of the above method.

It is to be understood that the summary is not intended to identify key or essential features of embodiments of the present invention, nor is it intended to be used to limit the scope of the present embodiment. Other features of the present embodiment will become easily comprehensible through the description below.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4A depicts a block diagram for a distributed environment in which an embodiment of the present invention may be implemented.

FIG. 4B depicts a block diagram for performing a distributed transaction in the distributed environment as depicted in FIG. 4A.

FIG. 5 depicts a block diagram for managing a distributed transaction in a distributed environment according to an embodiment of the present invention.

FIG. 6 depicts a flowchart of a method for managing a distributed transaction in a distributed environment according to an embodiment of the present invention.

FIG. 7 depicts a block diagram for a record for tracking data changes in an application system according to an embodiment of the present invention.

FIG. 8 depicts a block diagram for obtaining a record of a first application system during performing a first transaction and a second transaction according to an embodiment of the present invention.

FIGS. 9A and 9B depict block diagrams for records of the first application system according to an embodiment of the present invention, respectively.

FIG. 10 depicts a block diagram for records of the first application system according to an embodiment of the present invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve a plurality of consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

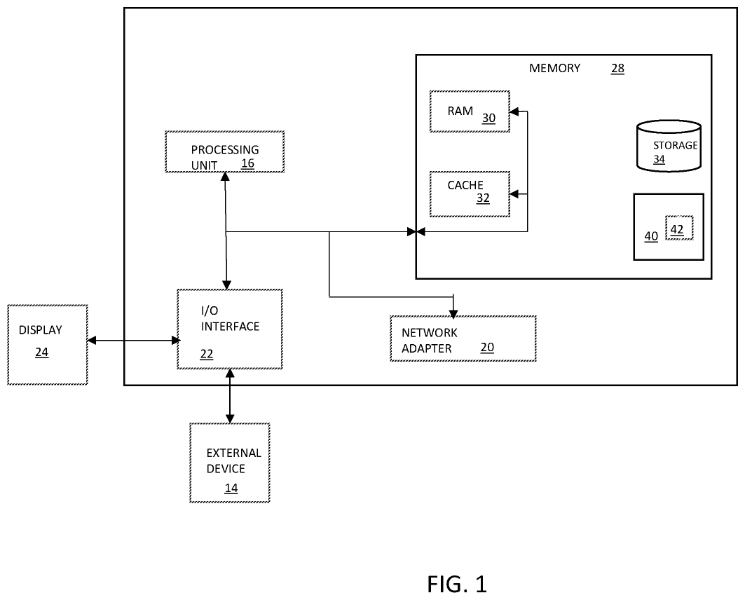

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

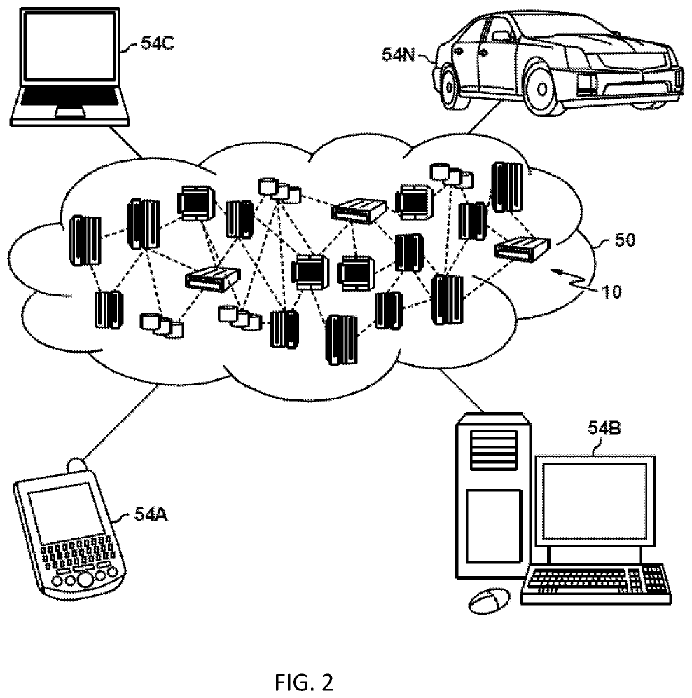

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

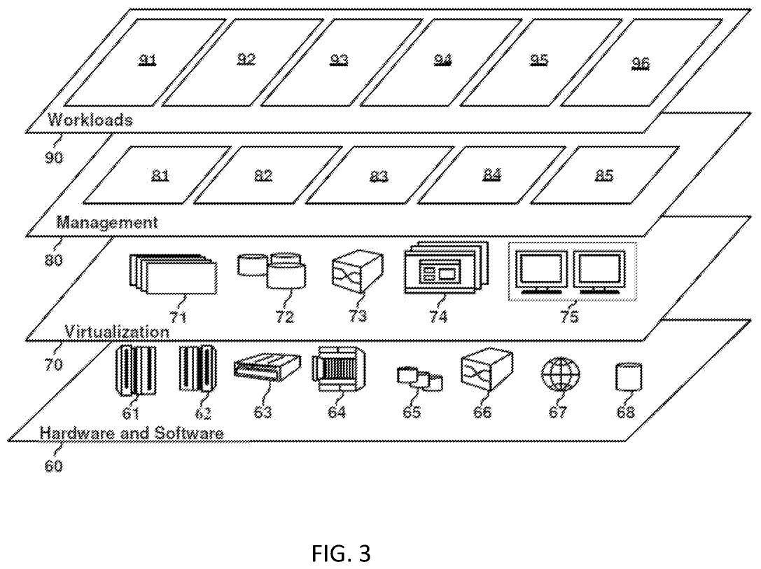

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and distributed transaction management 96.

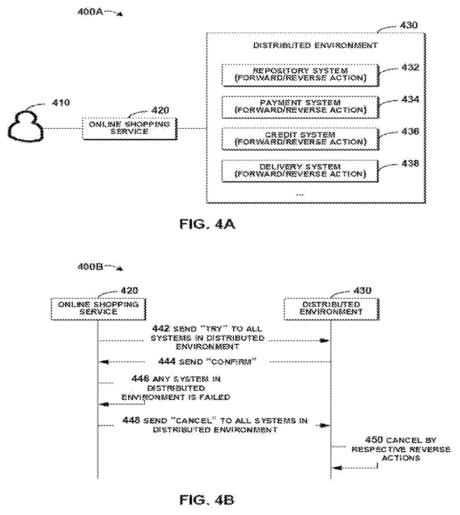

How to manage distributed transactions and determine values of data in the application systems effectively now becomes a hot focus. It should be noted that the processing of distributed transaction management 96 according to embodiments of this disclosure could be implemented by computer system/server 12 of FIG. 1. For the sake of clarity, embodiments of the present invention will be descripted in a distributed environment by taking a distributed shopping transaction as an example with reference to FIG. 4A. FIG. 4A depicts a block diagram 400A for a distributed environment 430 in which an embodiment of the present invention may be implemented. In FIG. 4A, a user 410 may access an online shopping service 420. Here, the online shopping service 420 may access all the related application systems in the distributed environment 430. FIG. 4B depicts a block diagram 400B for performing a distributed transaction in the distributed environment as depicted in FIG. 4A.

The distributed environment 430 may comprise a plurality of application systems, for example, a repository system 432 in which items that the user 410 can buy via the online shopping service 420 may be recorded, a payment system 434 in which the user's bank account for an item bought by the user 410 may be charged, a credit system 436 in which whether any coupon may be used for the payment may be checked and applied, and a delivery system 438 in which a delivery for the item to the user 410 may be arranged. Here, in the online shopping service 420, a plurality of actions are executed in the plurality of application systems 432, 434, 436 and 438, respectively. If the user 410 buys a cell phone with a price of 1000 USD, a repository action may cause the number of cell phones in the repository to be reduced by one, a payment action may cause 1000 USD from the user's account to be charged, a credit action may cause the user's credit to be increased, and a deliver action may cause a delivery order for the cell phone to be arranged.

As each of the above application systems works independently, the online shopping service 420 should coordinate all these application systems to ensure that all these application systems are accessed successfully in the shopping transaction. Afterwards, the shopping transaction may be completed upon all these application systems having been successfully accessed and all corresponding data in these application systems having been successfully updated. If a data in any of the above application systems fails to be accessed, the shopping transaction should be cancelled.

Reference will be made to FIG. 4B for more detail about a procedure of the shopping transaction. FIG. 4B depicts a block diagram for performing a distributed transaction in the distributed environment 430 as depicted in FIG. 4A. As depicted by an arrow 442 in FIG. 4B, the online shopping service 420 may first notify all the application systems in the distributed environment 430 that the shopping transaction will be performed by sending a “TRY” message to each of the application systems. After receiving the “TRY” message, each application system in the distributed environment 430 may check its preparation state, and then may send a “CONFIRM” message at an arrow 444 to the online shopping service 420 when ready.

The online shopping service 420 may count the number of the received “CONFIRM” messages at an arrow 446. If the online shopping service 420 receives a correct number of “CONFIRM” messages from all application systems in the distributed environment 430, the shopping transaction may be performed successfully. Otherwise, if any application system in the distributed environment 430 is failed to send the “CONFIRM” message, the shopping transaction fails and the online shopping service 420 may send “CANCEL” messages to all the application systems at an arrow 448. Next, respective application systems may cancel respective actions caused by the shopping transaction by respective corresponding reverse actions at an arrow 450.

By now, solutions have been developed for cancelling a forward action in a transaction by a reverse action, and each of the application systems should have its own reverse action. For example, the number of the cell phones in the repository should be increased by one in a reverse repository action, 1000 USD should be refunded to the user's account in a reverse payment action, the user's credit should be decreased in a reverse credit action, and the delivery order should be cancelled in a reverse deliver action. Although a reverse action may roll back the database in an application system to its previous state, technical engineers should design and develop an individual reverse action besides the forward action, which will increase workloads of the technical engineers.

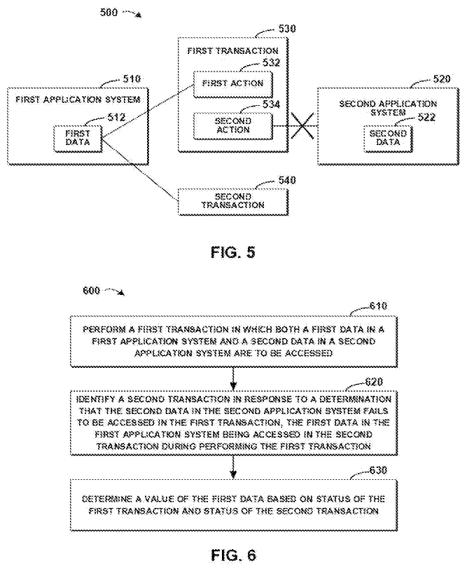

In view of the above drawbacks, embodiments of the present invention provide solutions for managing distributed transactions. Reference will be made to FIG. 5 for a brief description of the present invention. FIG. 5 depicts a block diagram 500 for managing distributed transactions in a distributed environment according to an embodiment of the present invention. Hereinafter, details of embodiments of the present invention will be described in the following context where an application system is accessed by a plurality of transactions, and the plurality of transactions increase a complexity when a transaction is cancelled.

FIG. 5 shows two application systems, where a first application system 510 (such as the payment system 434 in FIG. 4A) includes a first data 512 (such as data in a record for storing a balance of a bank account for the user 410), and a second application system 520 (such as the repository system 432 in FIG. 4A) includes a second data 522 (such as data in a record for storing the count of the cell phones). In a first transaction 530, the user 410 buys a cell phone with a price of 1000 USD, and the balance may be decreased by 1000 USD. In a second transaction 540, the user 410 buys a bus ticket with a price of 5 USD, and the balance may be decreased by 5 USD.

Suppose the balance of the user 410 has been successfully decreased by 1000 USD but the second data 522 in the second application system 520 cannot be accessed due to network delay or other reasons. At this point, the first transaction 530 should be cancelled and 1000 USD should be refunded to the user's balance. As the second transaction 540 has also changed the balance, the balance has been changed twice by the first transaction 530 and the second transaction 540, respectively. If the transaction 530 is cancelled, both changes in both transactions should be considered.

In the above scenario, the first transaction 530 (such as the shopping transaction for buying the cell phone) may be performed, in which both the first data 512 in the first application system 510 and the second data 522 in the second application system 520 are to be accessed. Although the first transaction 530 may involve a plurality of actions such as the repository action, the payment action, the credit payment action and the delivery action, a simplified example comprising the repository action and the payment action will be presented for illustration.

In the simplified example, the first action 532 may relate to payment and the second action 534 may relate to repository. The first data 512 in the first application system 510 may be accessed in the first transaction 530 via the first action 532. The second data 522 in the second application system 520 may be accessed in the first transaction 530 via the second action 534.

It is to be understood that actions 532 and 534 in the first transaction 530 should be performed in the first application system 510 and the second application system 520, respectively. In the situation of buying the cell phone, the balance may be decreased by 1000 USD and the count of the cell phone may be decreased by one. If any of the actions 532 and 534 is failed, the first transaction 530 is failed. For example, if the count of the cell phone cannot be changed, but the balance has been already decreased, then the first transaction 530 should be cancelled and 1000 USD should be refunded to the balance. However, as the balance is also changed by the second transaction 540, the second transaction 540 should be considered.

As depicted in FIG. 5, if the second data 522 in the second application system 520 fails to be accessed in the first transaction 530, then the second transaction 540 that has been completed during performing the first transaction 530 may be identified, because the first data 512 has been changed in the second transaction 540. Therefore, a value of the first data 512 may be determined by considering changes in both the first transaction 530 and the second transaction 540 so as to roll back the first data 512 to a suitable value if the first transaction 530 is cancelled.

Reference will be made to FIG. 6 for more detail about embodiments of the present invention, which depicts a flowchart of a method 600 for managing distributed transactions in a distributed environment according to an embodiment of the present invention. Steps at a plurality of blocks in FIG. 6 may be implemented by one or more processing units. It is to be understood that the present invention does not limit locations of the one or more processing units. For example, the one or more processing units may reside in the same computing device, alternatively, the one or more processing units may reside in different computing devices. Therefore, steps at the plurality of blocks may be implemented by the same computing device or different computing devices.

At block 610, the first transaction 530 may be performed, where both the first data 512 in the first application system 510 and the second data 522 in the second application system 520 are to be accessed in the first transaction 530. Here, the first transaction 530 may be the shopping transaction for buying the cell phone, where the first data 512 of the balance in the payment system and the second data 522 of the number of the cell phone in the repository system may be accessed in the shopping transaction. It is to be understood that as the present invention relates to distributed transaction management and thus only when data in different applications is to be accessed in the first transaction 530, the method 600 may be implemented.

At block 620, the second transaction 540 may be identified in response to a determination that the second data 522 in the second application system 520 fails to be accessed in the first transaction 530. The first data 512 in the first application system 510 has been accessed in the second transaction 540 during performing the first transaction 530. Continuing the above example, the second transaction 540 in which the first data 512 of the balance of the user 410 is also accessed due to a bus ticket may be identified.

At block 630, a value of the first data 512 may be determined based on status of the first transaction 530 and status of the second transaction 540. As in both of the first transaction 530 and the second transaction 540, the first data 512, with the above method 300, the value of the first data 512 that is changed in a failed distributed transaction may be determined directly based on status of a plurality of transactions in which the same data is accessed. Compared with the existing solution for developing a corresponding reserve action for each of the application system, it is unnecessary for technical engineers to develop an individual reverse action. Instead, status of the plurality of transactions may be recorded for determining the value of the first data 512 in an easier and more convenient manner.

According to embodiments of the present invention, changes to the first data 512 in the first transaction 530 and the second transaction 540 may be obtained, respectively. For example, as the first application system 510 runs, transactions in which the first application system 510 is accessed may be monitored to obtain the changes. Specifically, a first change to the first data 512 in the first transaction 530 may be obtained, and a second change to the first data 512 in the second transaction 540 may also be obtained. Continuing the above example, the first change relates to a decrease of 1000 USD in the balance, and the second change relates to a decrease of 5 USD in the balance.

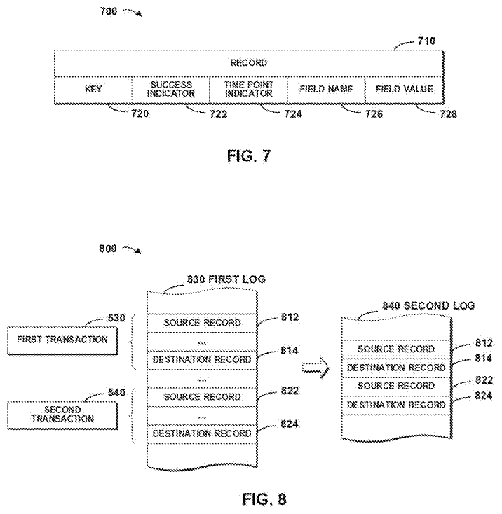

According to embodiments of the present invention, a record may be used for storing the change and reference will be made to FIG. 7 for illustration. FIG. 7 depicts a block diagram 700 for a record for tracking data changes in an application system according to an embodiment of the present invention. In FIG. 7, the record 710 may comprise a plurality of fields: a key 720 for representing an identification of the user such as an bank account number “123;” a success indicator 722 for representing whether the monitored transaction is completed or not; a time point indicator 724 for representing whether the record is collected before or after the completion of the monitored transaction; a field name 726 for representing a field of the first data 512; and a field value 728 for representing a value of the first data 512.

According to embodiments of the present invention, an integer “0” in the success indicator 722 represents a failure status, and an integer “1” represents a success status. An integer “0” in the time point indicator 724 represents that the record is obtained before the transaction is performed, and an integer “1” represents that the record is obtained after the transaction is completed. It is to be understood that the above integer values for the record are just examples and other values may be defined in other embodiments of the present invention.

In order to obtain the change, a source record may be generated for representing the value of the first data before the transaction is performed, and a destination record may be generated for representing the value of the first data after the transaction is completed. Reference will be made to FIG. 8 for details about generating and storing the records. FIG. 8 depicts a block diagram 800 for generating a record in the first application system during performing a first transaction and a second transaction according to an embodiment of the present invention.

With respected to the first transaction 530 for buying the cell phone, a first source record 812 may be generated according to the data structure in FIG. 7. Supposing the bank account number of the user 410 is “123,” the field name for the first data 512 is “BALANCE,” the value of the first data 512 before the first transaction 530 is performed is “2500.00 USD,” the value of the first data 512 after the first transaction 530 is completed is “1500.” At this point, the first source record 812 may be generated as (123, 0, 0, BALANCE, 2500.00), and the first destination record 814 may be generated as (123, 0, 1, BALANCE, 1500.00).

Similarly, a second source record 822 and a second destination record 824 for the second transaction 540 for the bus ticket may be generated, respectively. As the bus ticket costs 5 USD, the second source record 822 may be generated as (123, 0, 0, BALANCE, 1500.00), and the second destination record 824 may be generated as (123, 0, 1, BALANCE, 1495.00). Here, the source and destination records about each transaction in the first application system 510 may be stored in a first log 830. According to embodiments of the present invention, once the value of the first data 512 has been determined, the corresponding source and destination records may be removed from the first log 830 so as to prevent the first log 830 being too large.

According to embodiments of the present invention, in order to determining the value of the first data 512 if the first transaction 530 is cancelled, corresponding records may be copied to a second log 840. As depicted in FIG. 8, the first source record 812, the first destination record 814, the second source record 822, and the second destination record 824 may be copied to the second log 840. Here, operations for determining the value of the first data 512 may be based on records in the second log 840.

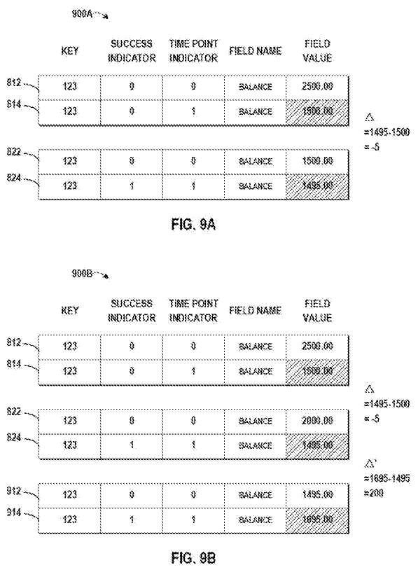

According to embodiments of the present invention, if the status of the first transaction 530 is failed while the status of the second transaction 540 is successful, then the changes to the first data 512 caused by the first transaction 530 and the second transaction 540 may be used to determine the value of the first data 512. Reference will be made to FIG. 9A for more details about how to determine the value of the first data 512 based on the first change and the second change.

FIG. 9A depicts a block diagram 900A for records in the first application system 510 according to an embodiment of the present invention. As depicted in FIG. 9A, a type of the first data 512 belongs to a numerical type, and thus a difference between the first change and the second change may be used for determining the value of the first data 512. Specifically, a shaded block in the first destination record 814 shows that the value of the first data 512 after the first transaction 530 is 1500.00, and a shaded block in the second destination record 824 shows that the value of the first data 512 after the second transaction 540 is 1495.00. Accordingly, a difference may be determined as 1495.00−1500.00=−5.00.

Next, the value of the first data 512 may be determined based on the determined difference and a first source value. As shown in the first source record 812, the first source value of the first data 512 is 2500.00. Therefore, the value of the first data 512 may be determined as 2500.00+(−5.00)=2495.00. Here, 2495.00 USD may be used as the value of the first data 512 in response to the first transaction being cancelled.

With embodiments of the present invention, if the first transaction 530 is failed and should be cancelled, the above method 600 may be used to determine the value of the first data 512 that is accessed in a plurality of transactions including the first transaction 530 and the second transaction 540. Accordingly, the technical engineer is not required to develop corresponding reverse action for each of the application systems. Instead, values of data in each of the application systems may be determined in an easier and more effective manner.

According to embodiments of the present invention, the first data 512 may be accessed a plurality of times in a plurality of transactions during the first transaction 530. At this point, all the transactions in which the first data 512 has been accessed may be identified. For example, a third transaction may be identified in response to a determination that the second data 522 in the second application system 520 fails to be accessed in the first transaction 530. Here, the first data 512 in the first application system 510 has been accessed in the third transaction during performing the first transaction 530.

Having provided details about determining the value of the first data 512 related to two transactions with reference to FIG. 9A, reference will be made to FIG. 9B for determining the value of the first data 512 when more transactions are involved. FIG. 9B depicts a block diagram 900B for records of the first application system according to an embodiment of the present invention. FIG. 9B shows records about three transactions, where the records 812 and 814 represent the values of the first data 512 before and after the first transaction is performed, respectively; the records 822 and 824 represent the values of the first data 512 before and after the second transaction is completed, respectively.

According to embodiments of the present invention, if the status of the first transaction 530 is failed while status of the third transaction is successful, then a third change to the first data in the first application system in the third transaction may be obtained. Supposing someone has transferred 200 USD to the user 410's account successfully during the first transaction 530, and then the balance may be increased by 200 USD. Here, the transfer transaction may be considered as the third transaction. At this point, a change to the first data 512 related to the third transaction may be obtained as shown in FIG. 9B.

Referring to FIG. 9B, the records 912 and 914 represent the values of the first data 512 before and after the third transaction, respectively. As shown, the balance of the account is 1495.00 before the transfer transaction, and the balance of the account is 1695.00 after the transfer transaction. Therefore, the value of the first data 512 may be determined further based on the third change, e.g. determined value of the first data 512 is based on both the first change and the second change. In FIG. 9B, the difference between the values 824 and 814 may be determined as Δ=1495.00−1500.00=−5.00, and the difference between the values 914 and 824 may be determined as Δ′=1695.00−1495.00=200.00. Further, the value of the first data 512 may be determined as 2500.00+Δ+Δ′=2695.00.

According to embodiments of the present invention, when the first data 512 is accessed successfully a plurality times in a plurality of transactions during the failed first transaction 530, the following formula 1 may be used to determine the value of the first data 512 in responsive the first transaction being cancelled.

Value=BI+Σᵢ₌₁ⁿΔᵢ=BI+Σᵢ₌₁ⁿAIᵢ₊₁−AIᵢ (1)

In the above Formula 1, Value represents a value for the first data 512 after the failed first transaction is cancelled, BI represents a value of the first data 512 before the first transaction 530 is performed, n represents the number of times that the first data 512 is accessed successfully in the plurality of transactions during the failed first transaction, AIᵢ₊₁ represents a value of the first data 512 after the (i+1)^{th} transaction is performed, and AIᵢ represents a value of the first data 512 after the i^{th} transaction is completed. In the above Formula 1, the plurality of transactions are sorted according to a chronological order.

The above paragraphs have provided descriptions about how to determine the value of the first data 512 of the numerical type. According to embodiments of the present invention, the first data 512 may be of a string type. Supposing the first data 512 is a field for storing an address of the user 410, and the first data 512 has been accessed in both the first and second transactions. When the first transaction is failed and the second transaction is successful, the first transaction should be cancelled. At this point, the value of the first data 512 may be determined directly based on a second destination value.

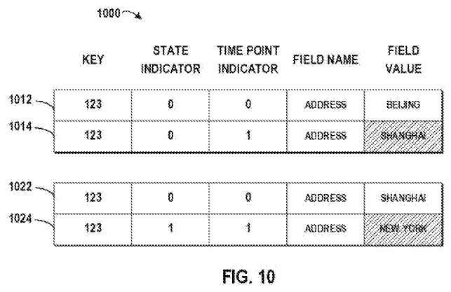

Reference will be made to FIG. 10 for more details, which figure depicts a block diagram 1000 for records of the first application system 510 according to an embodiment of the present invention. Supposing the first transaction 530 relates to changing the address from “Beijing” to “Shanghai,” and the second transaction 540 relates to changing the address from “Shanghai” to “New York,” then records related to the two transactions may be shown in FIG. 10. In FIG. 10, the addresses before and after the first transaction are “Beijing” and “Shanghai” (as shown in records 1012 and 1014), respectively. The addresses before and after the second transaction 540 are “Shanghai” and “New York” (as shown in records 1022 and 1024), respectively. Here, the value of the first data 512 may be determined as “New York” when the first transaction is cancelled.

In another embodiment, if the first data 512 is accessed successfully a plurality of time in a plurality of transaction during the failed first transaction, the value of the first data 512 may be determined based on the value after the last transaction is completed. For example, if in a third transaction completed later than the second transaction the address has been modified to “London,” then the value of the first data 512 may be determined as “London” when the first transaction is cancelled. As the data of the string type may be directly replaced by the latest value, with the embodiments of the present invention, the value of the first data 512 may be determined in a simple way.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
performing, by one or more processing units, a first transaction in which both a first data in a first application system and a second data in a second application system are to be accessed;
identifying, by one or more processing units, a second transaction in response to a determination that the second data in the second application system fails to be accessed in the first transaction, the first data in the first application system being accessed in the second transaction during performing the first transaction; and
determining, by one or more processing units, a value of the first data based on status of the first transaction and status of the second transaction.

2. The method according to claim 1, wherein the determining the value of the first data based on status of the first transaction and status of the second transaction comprises:
in response to the status of the first transaction being failed while the status of the second transaction being successful,
obtaining, by one or more processing units, a first change to the first data in the first transaction;
obtaining, by one or more processing units, a second change to the first data in the second transaction; and
determining, by one or more processing units, the value of the first data based on the first change and the second change.

3. The method according to claim 2, wherein the obtaining the first change to the first data in the first transaction further comprises:
obtaining, by one or more processing units, a first source value of the first data in the first application system before the first transaction is performed; and
obtaining, by one or more processing units, a first destination value of the first data in the first application system after the first transaction is completed.

4. The method according to claim 3, wherein the obtaining the second change to the first data in the second transaction further comprises:
obtaining, by one or more processing units, a second source value of the first data in the first application system before the second transaction is performed; and
obtaining, by one or more processing units, a second destination value of the first data in the first application system after the second transaction is completed.

5. The method according to claim 4, wherein the determining the value of the first data based on the first change and the second change further comprises:
in response to determining a type of the first data being a numerical type,
determining, by one or more processing units, a difference between the first change and the second change; and
determining, by one or more processing units, the value of the first data based on the determined difference and the first source value.

6. The method according to claim 5, further comprising:
identifying, by one or more processing units, a third transaction in response to a determination that the second data in the second application system fails to be accessed in the first transaction, the first data in the first application system being accessed in the third transaction during performing the first transaction;
in response to the status of the first transaction being failed while status of the third transaction being successful,
obtaining, by one or more processing units, a third change to the first data in the first application system in the third transaction; and
determining, by one or more processing units, further value of the first data further based on the third change.

7. The method according to claim 4, wherein the determining the value of the first data based on the first change and the second change further comprises:
in response to determining a type of the first data being a string type,
determining, by one or more processing units, the value of the first data based on the second destination value.

8. The method according to claim 1, further comprising:
storing, by one or more processing units, a first source value of the first data, a first destination value of the first data, a second source value of the first data, and a second destination value of the first data to a log.

9. A computer-implemented system, comprising a computer processor coupled to a computer-readable memory unit, the memory unit comprising instructions that when executed by the computer processor implements a method comprising:
performing a first transaction in which both a first data in a first application system and a second data in a second application system are to be accessed;
identifying a second transaction in response to a determination that the second data in the second application system fails to be accessed in the first transaction, the first data in the first application system being accessed in the second transaction during performing the first transaction; and
determining a value of the first data based on status of the first transaction and status of the second transaction.

10. The system according to claim 9, wherein the determining the value of the first data based on status of the first transaction and status of the second transaction comprises:
in response to the status of the first transaction being failed while the status of the second transaction being successful,
obtaining a first change to the first data in the first transaction;
obtaining a second change to the first data in the second transaction; and
determining the value of the first data based on the first change and the second change.

11. The system according to claim 10, wherein the obtaining the first change to the first data in the first transaction further comprises:
obtaining a first source value of the first data in the first application system before the first transaction is performed; and
obtaining a first destination value of the first data in the first application system after the first transaction is completed.

12. The system according to claim 11, wherein the obtaining the second change to the first data in the second transaction further comprises:
obtaining a second source value of the first data in the first application system before the second transaction is performed; and
obtaining a second destination value of the first data in the first application system after the second transaction is completed.

13. The system according to claim 12, wherein the determining the value of the first data based on the first change and the second change further comprises:
in response to determining a type of the first data being a numerical type,
determining a difference between the first change and the second change; and
determining the value of the first data based on the determined difference and the first source value.

14. The system according to claim 13, wherein the method further comprises:
identifying a third transaction in response to a determination that the second data in the second application system fails to be accessed in the first transaction, the first data in the first application system being accessed in the third transaction during performing the first transaction;
in response to the status of the first transaction being failed while status of the third transaction being successful,
obtaining a third change to the first data in the first application system in the third transaction; and
determining further value of the first data further based on the third change.

15. A computer program product, the computer program product comprising a computer readable storage medium having program instructions embodied therewith, the program instructions executable by an electronic device to cause the electronic device to perform a method comprising:
performing a first transaction in which both a first data in a first application system and a second data in a second application system are to be accessed;
identifying a second transaction in response to a determination that the second data in the second application system fails to be accessed in the first transaction, the first data in the first application system being accessed in the second transaction during performing the first transaction; and
determining a value of the first data based on status of the first transaction and status of the second transaction.

16. The computer program product according to claim 15, wherein the determining the value of the first data based on status of the first transaction and status of the second transaction comprises:
in response to the status of the first transaction being failed while the status of the second transaction being successful,
obtaining a first change to the first data in the first transaction;
obtaining a second change to the first data in the second transaction; and
determining the value of the first data based on the first change and the second change.

17. The computer program product according to claim 16, wherein the obtaining the first change to the first data in the first transaction further comprises:
obtaining a first source value of the first data in the first application system before the first transaction is performed; and
obtaining a first destination value of the first data in the first application system after the first transaction is completed.

18. The computer program product according to claim 17, wherein the obtaining the second change to the first data in the second transaction further comprises:
obtaining a second source value of the first data in the first application system before the second transaction is performed; and
obtaining a second destination value of the first data in the first application system after the second transaction is completed.

19. The computer program product according to claim 18, wherein the determining the value of the first data based on the first change and the second change further comprises:
in response to determining a type of the first data being a numerical type,
determining a difference between the first change and the second change; and
determining the value of the first data based on the determined difference and the first source value.

20. The computer program product according to claim 19, further comprising:
identifying a third transaction in response to a determination that the second data in the second application system fails to be accessed in the first transaction, the first data in the first application system being accessed in the third transaction during performing the first transaction;
in response to the status of the first transaction being failed while status of the third transaction being successful,
obtaining a third change to the first data in the first application system in the third transaction; and
determining further value of the first data further based on the third change.
